(19) United States
(12) Patent Application Publication
(10) Pub. No.: US 2011/0035306 A1
(43) Pub. Date: Feb. 10, 2011

(54) System and method for buying and selling securities

(75) Inventors: Peter K. Martin, Fair Haven, NJ (US); Gregory Shulman, New York, NY (US); Aura Yanavi, Clifton, NJ (US)

Correspondence Address: PATENT DOCKET ADMINISTRATOR;LOWENSTEIN SANDLER PC, 65 LIVINGSTON AVENUE, ROSELAND, NJ, 07068, US

(73) Assignee: JPMorgan Chase Bank, N.A., New York, NY (US)

(21) Appl. No.: 11/245,617

(22) Filed: Oct. 7, 2005

Related U.S. Application Data
(60) Provisional application No. 60/692,287, filed on Jun. 20, 2005.

(51) Int. Cl. G06Q 40/00

(52) U.S. Cl. 705/37

(57) ABSTRACT

A computer-implemented method for trading a financial instrument. The method can include receiving an instrument designation for a financial instrument, receiving an offset value, related to the instrument, and receiving an actuation of at least one of a better buyer selector and a better seller selector related to the instrument. The method can include receiving a base value related to the instrument, receiving a timeout rule related to the instrument, and receiving a timeout value related to the instrument. The timeout rule can be an interval type, and the timeout value can be a time interval. The timeout rule can be a custom type, and the timeout value can be a mathematical expression. In addition, the method can include generating a request to buy the instrument at a value of the offset above the bid price for the instrument, and buying the instrument.

### CROSS-REFERENCE TO RELATED APPLICATION

This application claims the benefit of U.S. Provisional Patent Application No. 60/692,287, filed Jun. 20, 2005, the entire disclosure of which is hereby incorporated herein by reference.

### FIELD OF THE INVENTION

The present invention relates generally to securities trading, and, more particularly, to systems and methods for buying and selling securities.

### BACKGROUND OF THE INVENTION

In today's investing environment, there are certain occasions where a trader may want to buy or sell a security at an accelerated pace. For example, a trader may want to increase his or her stake in a company up to a certain percentage of ownership to increase voting control of the company. Further, a trader may want to increase his or her stake in a company quickly because the trader has determined that the stock will be a good value in the future. Alternatively, a particular security may have a low volume of market availability for purchasing, and thus, purchasing a relatively large volume of a security may require a relatively long period of time.

Similarly, a trader may desire to sell a security at a relatively rapid pace because he or she wishes to reduce a percentage of ownership in a company below a certain percentage, the trader has determined that the market price of the security will drop quickly, or, there is a relatively small supply of buyers for the particular security to be sold.

Further, a trader may want to buy or sell a security relatively quickly because the trader is investing under a specific protocol that requires an invested portfolio to maintain a composition consisting of certain predetermined percentages of certain categories of securities.

When a trader is attempting to buy a security at a relatively rapid pace, a typical approach is to bid more than the market price for the security, thus paying a premium for the security, in return for a more rapid acquisition of a certain volume of the security. This type of buying is complicated by the fact that the market price of a security may change as the security is being purchased, and the trader's over-bid may become too high, thus costing the trader a greater than necessary premium, or being too low, and not achieving the desired rapid buying of the security. In a manner similar to that of the rapid buying scenario, described above, a trader may attempt to rapidly sell a security by offering the security for sale at less than the market rate. Accordingly, the selling of a security can be similarly affected by changes in the market price of the security throughout the duration of the selling process.

Further complications are introduced if multiple securities are involved in the rapid buying or selling, with each of the multiple securities being subject to changing market prices throughout the duration of the buying or selling process.

Thus, there is a need for an improved system and method for selling securities.

### SUMMARY OF THE INVENTION

Embodiments of the present invention satisfy these and other needs by providing to a trader improved systems and methods for buying and selling securities.

Embodiments of the invention allows traders, or users, in an electronic trading environment, to quickly become better buyers or better sellers in a manner that would facilitate their trades getting executed, and executed in a relatively fast manner.

Embodiments of the invention are directed a computer-implemented method for buying or selling a security. The method can include receiving an instrument designation for an instrument, receiving an offset value, related to the instrument, and receiving an actuation of at least one of a better buyer selector and a better seller selector related to the instrument. The method can include receiving a base value related to the instrument, receiving a timeout rule related to the instrument, and receiving a timeout value related to the instrument. The timeout rule can be an interval type, and the timeout value can be a time interval. The timeout rule can be a custom type, and the timeout value can be a mathematical expression. In addition, the method can include generating a request to buy the instrument at a value of the offset above the bid price for the instrument, as well as buying the instrument. The method can include receiving an offer price for the instrument, generating a request to sell the instrument at a value of the offset below the offer price of the instrument, and selling the instrument.

### BRIEF DESCRIPTION OF THE DRAWINGS

The present invention will be more readily understood from the detailed description of exemplary embodiments presented below considered in conjunction with the attached drawings, of which:

FIG. 1 is an exemplary screen shot illustrating a Turbo ETSwitch configuration, in accordance with an embodiment of the present invention;

FIG. 2 is an exemplary screen shot illustrating a deactivated Turbo ETSwitch, in accordance with an embodiment of the present invention;

FIG. 3 is an exemplary screen shot illustrating an activated Turbo ETSwitch, in accordance with an embodiment of the present invention;

FIG. 4 is an exemplary screen shot illustrating a portion of a trading system including a deactivated Turbo ETSwitch, in accordance with an embodiment of the present invention;

FIG. 5 is an exemplary screen shot illustrating a configuration setting for a Turbo ETSwitch, in accordance with an embodiment of the present invention;

FIG. 6 is an exemplary UML schematic diagram showing program structure relationships, in accordance with an embodiment of the present invention;

FIG. 7 is an exemplary flow diagram illustrating the relationship of an artificial intelligence module and a Turbo ETSwitch, in accordance with an embodiment of the present invention; and

FIG. 8 is a schematic of an exemplary system architecture, in accordance with embodiments of the present invention.

It is to be understood that the attached drawings are for purposes of illustrating the concepts of the invention and may not be to scale.

### DETAILED DESCRIPTION OF THE INVENTION

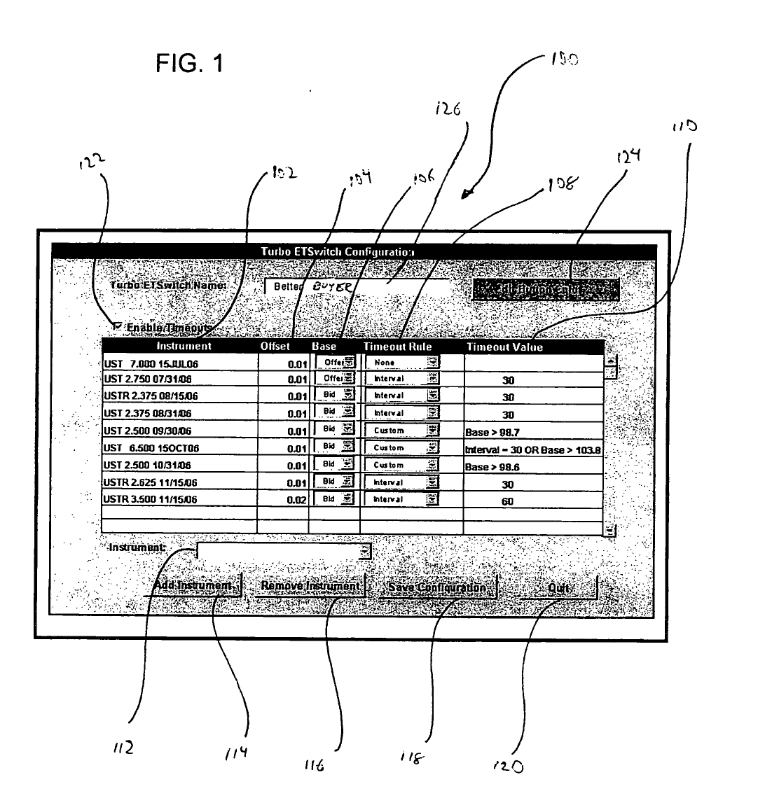

With reference to FIG. 1, there is shown a Turbo ETSwitch configuration screen 100 in accordance with certain embodiments of the invention. As used herein, a Turbo ETSwitch can be a “better buyer” switch or a “better seller” switch, facilitating a more rapid buy or sell, respectively, by a trader. A better buyer/seller Turbo ETSwitch is defined by a set of one or more instruments, and a set of corresponding instructions related to buying and/or selling the securities.

The computer system allows the trader to define better buyer and better seller ETSwitches and persistently retains the definitions. A trader is can edit these definitions.

The instruments field 102 lists instruments, or securities to be configured with a Turbo ETSwitch. The offset field 104 lists the offset value to some base price for each of the respective instruments. The base field 106 is used to denote the base value for which the offset is measured. The base can be selected from offer or bid prices, or any other designated type of a base price relevant to a given trading activity. The timeout rule field 108 denotes the type of timeout used for the Turbo ETSwitch for the selected security. Choices of timeout rule can be none, a predetermined interval, or a custom timeout rule. The timeout value field 110 denotes a timeout value to be used in conjunction with a corresponding timeout rule. For example, in certain embodiments, if no timeout rule is selected, then, no timeout value is used. If an interval timeout rule is selected, the timeout value can be a value, such as 30 minutes. If a custom timeout rule is selected, the timeout value can be a Boolean or logical expression, such as “Interval=30 OR Base>103.8.” The timeout rules can be selectively enabled or disabled via the enable timeouts checkbox 122.

The adding of additional instruments to the Turbo ETSwitch configuration can be initiated via the add instrument button 114. Similarly, instruments can be removed from the Turbo ETSwitch configuration via the remove instrument button 116. Once a user is satisfied with a particular configuration, the configuration can be stored via the save configuration button 118. The stored configuration is associated with the name typed into the Turbo ETSwitch name field 126. The user may leave the Turbo ETSwitch configuration screen 100 by selecting the quit button 120

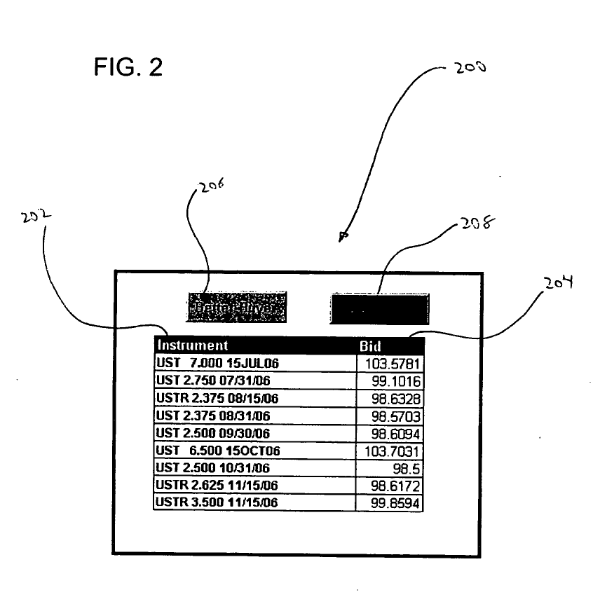

With reference to FIG. 2, there is shown a trading system screen 200 in accordance with embodiments of the invention. Instruments to be traded are listed in the instruments column 202, while corresponding bid prices are listed in bid column 204. A better buyer button 206 and a better seller button 208 are also displayed on the screen. By a predetermined color scheme, and or lack of flashing colors, a user can determine that neither better buyer button 206, nor better seller button 208, has been activated.

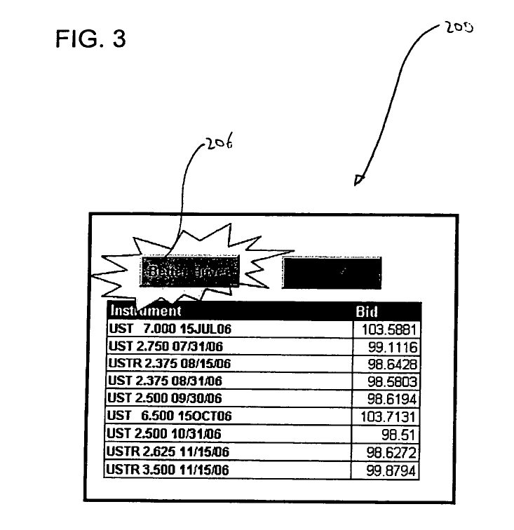

With added reference to FIG. 3, upon a user selecting better buyer button 206, butter buyer button 206 changes color, begins flashing, or otherwise provides a clear indication that better buyer mode has been enabled. Better seller mode can be enabled in a similar manner.

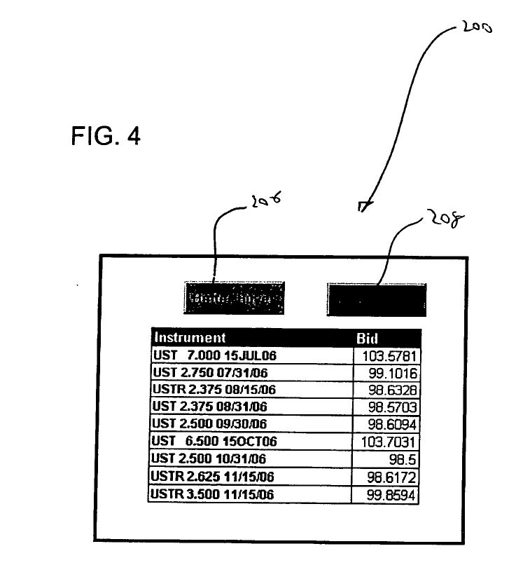

With reference to FIG. 4, a Turbo ETSwitch can be de-activated by way of a variety of methods. In a first method, a user clicks on the flashing button 206, 208. In a second method, a condition exists where every instrument within the Turbo ETSwitch has a timeout rule defined and enabled and all timeouts have been triggered so that there is no instrument associated with this Turbo ETSwitch still “turbo-active” (i.e., with the offset applied). In some embodiments, a Turbo ETSwitch can be de-activated when a predetermined amount of shares is bought and/or sold. In some embodiments, an overseer or equalizer function that monitors trades across an enterprise's trading systems can be implemented. The overseer functionality can deactivate a Turbo ETSwitch based on the amount of shares bought and/or sold across the trading system or systems. In some embodiments, if a first Turbo ETSwitch is engaged and there is a second Turbo ETSwitch switch within the enterprise that is configured to function in a manner opposite to that of the first Turbo ETSwitch, an alert can be initiated, and an internal trade (within the enterprise) can be implemented. In some embodiments, the overseer can detect that there are multiple Turbo ETSwitches switches configured to buy or sell the same financial instruments, and deactivate one or more Turbo ETSwitches switches to prevent over buying or selling. In addition, in some embodiments, a failsafe algorithm can be implemented to turn off one or more Turbo ETSwitches when the market is distressed, and or volatile, based on predetermined parameters.

In some embodiments, when a Turbo ETSwitch 206, 208 is deactivated by any of the methods described above, the button stops flashing. In this manner, a user is provided with a visual indication that a given Turbo ETSwitch is currently inactive.

Deactivation of a Turbo ETSwitch means that offsets associated with each instrument within the Turbo ETSwitch configuration are subtracted from the target (or Base) price.

If a given instrument has already been deactivated via a timeout, then upon clicking on, or deactivating the Turbo ETSwitch button, the offset is not subtracted again (i.e., the offset for a given instrument within a Turbo ETSwitch is subtracted from the base price exactly once regardless of the method of deactivation (clicking on the button (manual deactivation) or timeout deactivation).

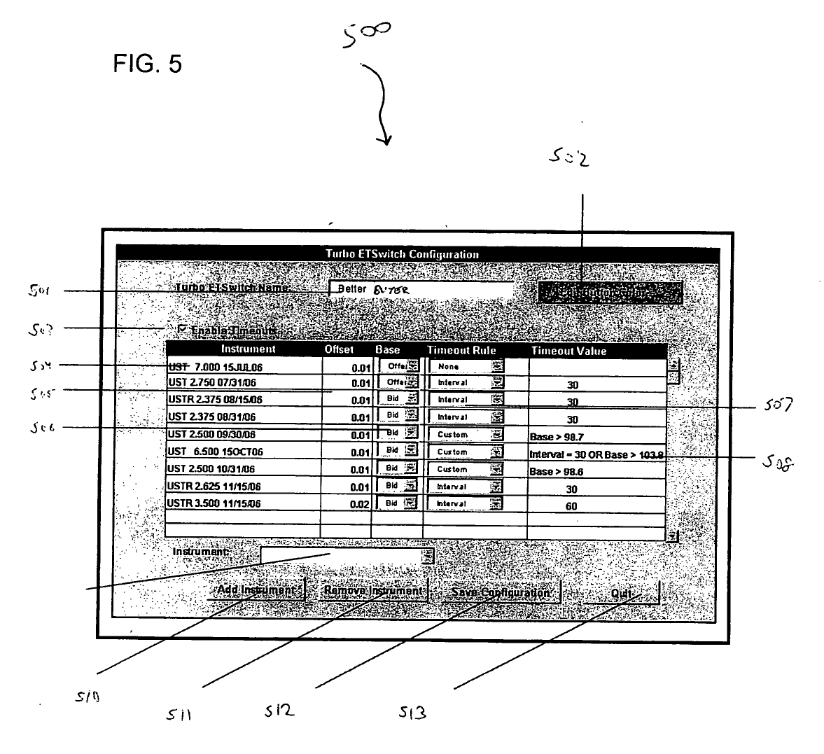

With reference to FIG. 5, in use, a user enters unique name for the Turbo ETSwitch. Step 501. Next, a user defines the color for the pushbutton associated with this Turbo ETSwitch. Step 502. Then, the user checks “enable timeouts” to allow for instrument specific timeout configurations to be activated when Turbo ETSwitch is activated. Step 503. In certain embodiments, an instrument-specific timeout will only be activated when this global flag is enabled. Next, a Turbo ETSwitch is associated with one or more instruments. Step 504.

Each instrument within a given Turbo ETSwitch can have the offset to the price defined. Step 505. This is the value that will be added to the base price when a Turbo ETSwitch is activated, and subtracted from the base price when Turbo ETSwitch is deactivated. The value can be positive or negative. The base (506) defines the target price that will be adjusted with the offset. The base can be any of a bid, mid, offer, last-traded, or others, as are known in the art.

Each instrument can have an optional timeout definition. When instrument timeout rule (507) is defined, and the global timeout flag is enabled, the timeout will be activated when a Turbo ETSwitch is activated. The timeout rule identifies the type of timeout to be processed. The rule can include, in certain circumstances, a time interval in seconds, or, alternatively, a combination of a time interval and price levels.

Timeout value (508) is an expression associated with a timeout rule. For example, if a timeout rule is “Interval”, the timeout value is the numeric value for the maximum number of seconds, or some other time interval, to pass, until the offset is automatically reversed. If a user deactivates the entire Turbo ETSwitch manually, before the instrument-specific timeout is activated, then the timeout function for that instrument can be cancelled. A user can select instruments to be associated with a given Turbo ETSwitch from the pick list. Generally, a given instrument may be associated with zero, one, or many Turbo ETSwitches.

A user can click on an “Add Instrument” button (510) to add the instrument in the “Instrument” selection list to the Turbo ETSwitch instrument set. When a new instrument is added to the Turbo ETSwitch, the default offset is “0,” and the default timeout rule is “None”.

If desired, the user clicks on a “Remove Instrument” button to (511) to remove an instrument currently selected in the instrument grid. A user clicks “Save Configuration” to persist this configuration to some permanent storage. Step 512. Next, a user clicks on a “Quit” button to exit the Turbo ETSwitch configuration module without saving any unsaved changes. Step 513. In some embodiments, instruments bought or sold can include stocks, U.S. treasuries, agencies, options and futures. In some embodiments, the instruments bought or sold can include any financial security or derivative instrument, and/or commodity, including commodity derivatives. Commodities bought or sold can include, by way of non-limiting example, gas, oil, sugar, coffee, pollution credits, hurricane warrants, as well as others. In some embodiments, instruments bought or sold can include items listed on auction sites, such as, for example, eBay, and Yahoo! Auction.

With reference again to FIGS. 2-4, the Turbo ETSwitch “better buyer” button, or selector 206 or a “better seller” button, or selector 208 is a button that can allow a 1-click activation and 1-click de-activation of the offset adjustments. It has a toggle behavior, wherein a first click activates the Turbo ETSwitch, and a second click de-activates the Turbo ETSwitch. In some embodiments, “better buyer” button, or selector 206 and/or a “better seller” button, or selector 208 can be any computer interface selector, as would be known to those skilled in the art, such as, by way of non-limiting example, a toggle button, radio switch, slide bar, text input field, as well as others. A user may have many Turbo ETSwitches configured. Each Turbo ETSwitch can be associated with a set of Instruments (202) that may be associated with some other Turbo ETSwitches. A trading system can include one or more instruments. A given instrument may be associated with zero, 1, or many Turbo ETSwitches. Instruments within a Trading System will have various prices, for example, an instrument will have a bid, ask, mid, last traded price at any moment in time.

With further reference to FIGS. 2-4, when a user activates the Turbo ETSwitch 206 (1-click on the associated push button), the button 206 begins to flash (see FIG. 3). In this manner, a user has a visual indicator that a given Turbo ETSwitch is currently active. For the duration of the Turbo ETSwitch active period, the price configured to be the target (or Base) of the offset adjustment is incremented by the amount of offset (when offset is negative the price is effectively decremented). When Timeout is triggered, the offset adjustment is automatically reversed and the target (or Base) price is decremented by the amount of offset. When the Turbo ETSwitch is deactivated, the Turbo ETSwitch functionality is deactivated.

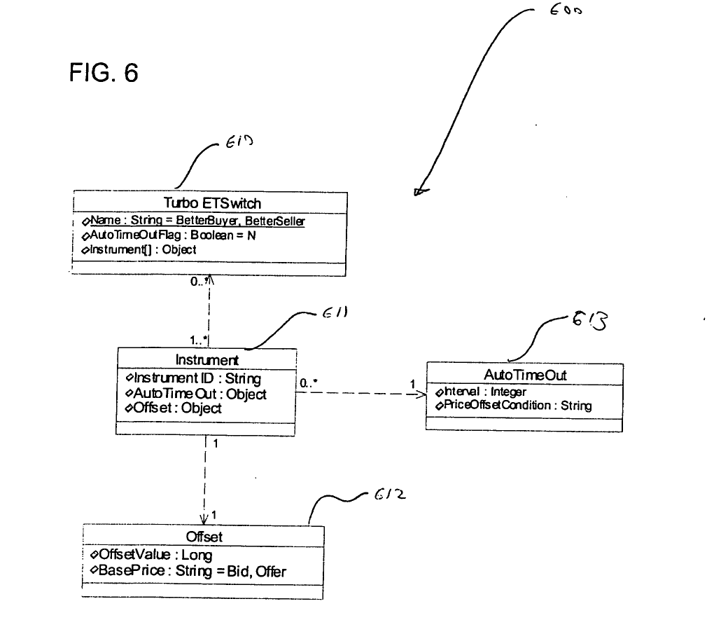

With reference to FIG. 6, there is shown a unified modeling language (UML) representation of an embodiment of the invention. As would be apparent to one skilled in the art, when informed by the present disclosure, the relationships of the Turbo ETSwitch 610, instrument 611, offset 612, and auto timeout 613 functionality blocks are shown. The system can be implemented on one or more processors, communicable over a network, such as an intranet, or the Internet.

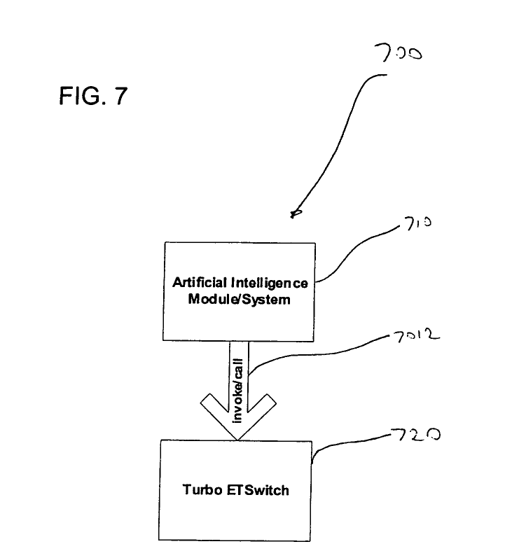

With reference to FIG. 7, embodiments of the present invention can make use of an artificial intelligence front end 710, which can invoke a call 712 to the above-described Turbo ETSwitch software 720. Thus, decisions about when to activate Turbo ETSwitch protocol, as well as other decisions, can be facilitated by an artificial intelligence front end, instead of by manual decisions of a user.

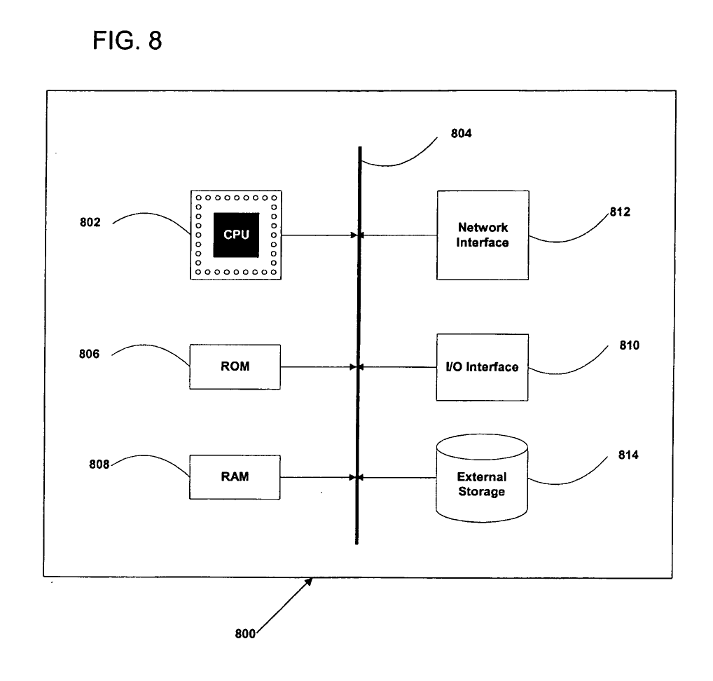

With reference to FIG. 8, embodiments of the invention can be implemented via a computer processing system 800. The system 800 includes at least one processor (hereinafter processor) 802 operatively coupled to other components via a system bus 804. A read-only memory (ROM) 806, a random access memory (RAM) 808, an I/O interface 810, a network interface 812, and external storage 814 are operatively coupled to the system bus 804. Various peripheral devices such as, for example, a display device, a disk storage device (e.g., a magnetic or optical disk storage device), a keyboard, and a mouse, may be operatively coupled to the system bus 104 by the I/O interface 810 or the network interface 812.

In some embodiments, the computer system 800 may be a standalone system or be linked to a network via the network interface 812. The network interface may be linked to various types of networks, including a local area network (LAN), a wide area network (WAN), an intranet, a virtual private network (VPN), and the Internet.

The external storage 814 may be implemented using a database management system (DBMS) managed by the processor 802 and residing on a memory such as a hard disk. However, it should be appreciated that the external storage 814 may be implemented on one or more additional computer systems. For example, the external storage 114 may include a data warehouse system residing on a separate computer system.

In other embodiments, other alternative computing systems and/or environments can be used without departing from the spirit and scope of the invention, as would be understood by one skilled in the art, as informed by the present disclosure.

Thus, embodiments of the invention allow users or traders in an electronic trading environment to quickly become better buyers or better sellers, thus facilitating their trades getting executed in a relatively fast manner.

In use, embodiments of the invention provide for a display of “Better Buyer” and “Better Seller” buttons. Upon clicking one of the buttons, a better bid/offer price will be generated based on the “Better Buyer” or “Better Seller” definitions and send to the specified Electronic Communication Network(s) (ECN).

For example, in use, a trader can define a “Better Buyer” ETSwitch as a +0.01 basis points (bps) increase over the market bid price for the set of instruments he or she is trading. The trader saves that definition in the electronic trading system. Then, the trader can identify the market in which the trader would like to become better buyer (e.g., TradeWeb), and clicks “Better Buyer” button. In some embodiments, the underlying system's configuration or selection of a base identifies the market. Markets used by some embodiments include, by way of non-limiting example, the New York Stock Exchange, the Chicago Mercantile Exchange, eBay, Yahoo Auction, and electronic communications networks (ECNs), such as TradeWeb and eSpeed. The button starts blinking identifying that requests for quotes (RFQs) are being generated that contain +0.01 bps above the current bid prices of selected securities (that trader specified in “Better Buyer” Turbo ETSwitch) in TradeWeb, or another platform, if used. This operation greatly improves the probability that the trader's bid price will be taken by the market. When trader wants to get out of being a “Better buyer,” he clicks “Better Buyer” button again and it stops blinking causing the electronic trading system to stop publishing better prices (i.e., in this example offsets are decremented by 0.01 bps and republished, so that prices revert to the levels prior to activating “Better Buyer” Turbo ETSwitch).

A similar operation can be applied if the trader wants to become a “Better Seller.” In such a situation, the trader can define a “Better Seller ETSwitch as a −0.01 bps decrease over the market offer price for the set of instruments that the trader is trading. The trader then saves that definition in the electronic trading system. Next, the trader can identify the market in which the trader would like to become better seller (e.g. TradeWeb), and clicks “Better Seller” button. The button starts blinking identifying that RFQs are getting generated that have a value 0.01 bps bellow the current ask prices of selected securities (that the trader specified in “Better Seller” Turbo ETSwitch) in Tradeweb. This operation greatly increases the probability that the trader's ask price will be taken by the market. When the trader wants to stop being a “Better Seller,” the trader clicks “Better Seller” button again and it stops blinking causing the electronic trading system to stop publishing better prices (i.e., in this example offsets are incremented by 0.01 bps and republished, so that prices revert to the levels prior to activating “Better Seller” Turbo ETSwitch).

Embodiments of the invention can be directed to other trading platforms such as those directed to commodities, auction sites, such as E-Bay, as well as others.

In certain embodiments, an instrument can be linked with both better buyer and a better seller functionality. Thus, in an arbitrage setting, an instrument can be linked to both buy and sell instructions.

In certain embodiments, a Turbo ETSwitch can be configured such that the system is a better buyer under a first set of market circumstances, and/or a better buyer under a second set of market circumstances, and/or neither a buyer nor a seller under a third set of market circumstances.

In certain embodiments, a timeout rule can include an “acceleration mode” whereby the time interval in which the Turbo ETSwitch is active can be shortened (the Turbo ETSwitch can be deactivated) under certain circumstances, such as certain pricing levels, price volatility, or market pricing and volatility levels. In alternative embodiments, the time interval can be lengthened under certain circumstances.

In certain embodiments, different cells or instruments can be linked such that the Turbo ETSwitch functionality related to one instrument is tied, or related to the ETSwitch of one or more other instruments. This type of linking can be employed, for example, in circumstances where it is known that a first instrument typically increases in price in correlation to a second instrument decreasing in price. Alternatively, other linking correlations can be used, as would be known to one of skill in the art, as informed by the present disclosure.

It is to be understood that the exemplary embodiments are merely illustrative of the invention and that many variations of the above-described embodiments can be devised by one skilled in the art without departing from the scope of the invention. It is therefore intended that all such variations be included within the scope of the following claims and their equivalents.

1. A computer-implemented method for trading a financial instrument, the method comprising the steps of:
activating, by at least one processor, at least one actuation of at least one of a better buyer selector and a better seller selector for the instrument, said better buyer selector functions to activate a request to buy the instrument and said better seller selector functions to activate a request to sell the instrument; and
deactivating, by said at least one processor, the actuation of the at least one of a better buyer selector and a better seller selector based on parameters; wherein said steps of activating and deactivating comprising toggling, by said at least one processor, between the activating and the deactivating of the actuation of the at least one of a better buyer selector and a better seller selector.

2. The method of claim 1, comprising the steps of:
receiving, by said at least one processor, an instrument designation for the instrument;
receiving, by said at least one processor, an at least one offset value, wherein said offset value is a value to a base price for the instrument; and
receiving a base value, wherein said base value is a value for which the offset is measured for the instrument.

3. The method of claim 2 wherein said offset value is added to the base value upon said activation of one of a better buyer selector and a better seller selector.

4. The method of claim 2 wherein said offset value is subtracted from the base value upon said deactivation of one of a better buyer selector and a better seller selector.

5. The method of claim 1 further comprising monitoring said trading activity of the instruments at said actuation.

6. The method of claim 2 comprising the step of: receiving, by said at least one processor, a bid price for the instrument upon the actuation of the at least one better buyer selector.

7. The method of claim 6 comprising the step of:
generating, by said at least one processor, request to buy the instrument at a value of the offset above the bid price for the instrument.

8. The method of claim 1 comprising the step of:
receiving, by said at least one processor, an offer price for the instrument upon the actuation of the at least one better seller selector.

9. The method of claim 8 comprising the step of:
generating, by said at least one processor, a request to sell the instrument at a value of the offset below the offer price of the instrument.

10. The method of claim 1 further comprising monitoring, by said at least one processor, a market for market condition.

11. The method of claim 1 wherein said deactivating the actuation is based on a timeout, wherein said time out comprise one of a custom timeout and an interval timeout.

12. (canceled)

13. (canceled)

14. The method of claim 7 comprising the step of buying, by said at least one processor, the instrument.

15. (canceled)

16. (canceled)

17. The method of claim 9 comprising the step of selling, by said at least one processor, the instrument.

18-26. (canceled)

27. A computer-implemented method for trading a financial instrument, the method comprising the steps of:
activating, by at least one processor, a first actuation of at least one of a better buyer selector and a better seller selector for the instrument;
activating, by said at least one processor, a second actuation of a better buyer selector and a better seller selector for the instrument;
monitoring, by said at least one processor, trading activity of the instruments at said first and second actuations; and
deactivating, by said at least one processor, one of the first and the second actuations when the instrument being traded at the first actuation is same as the instrument being traded at the second actuation; wherein said steps of activating and deactivating comprising toggling, by said at least one processor, between the activating of the first and the second actuations and the deactivating of the first and the second actuations of the at least one of a better buyer selector and a better seller selector.

28. (canceled)

29. A computer-implemented system for trading a financial instrument, the system comprising:
one or more storage devices; and
one or more processors, coupled to the storage devices, the processors programmed and configured to activate at least one actuation of at least one of a better buyer selector and a better seller selector for the instrument, said better buyer selector functions to activate a request to buy the instrument and said better seller selector functions to activate a request to sell the instrument;
said processors programmed and configured to deactivate the actuation of the at least one of a better buyer selector and a better seller selector based on parameters, wherein said activation and deactivation comprise toggle between the activation and the deactivation of the actuation of the at least one of a better buyer selector and a better seller selector.

30. The system of claim 29, the processors programmed and configured to receive an instrument designation for the instrument;
to receive an at least one offset value, wherein said offset value is a value to a base price for the instrument and to receive a base value, wherein said base value is a value for which the offset is measured for the instrument.

31. The system of claim 30 wherein said processor programmed and configured to add said offset value to the base value upon said activation of one of a better buyer selector and a better seller selector.

32. The system of claim 30 wherein said processor programmed and configured to subtract said offset value from the base value upon said deactivation of one of a better buyer selector and a better seller selector.

33. The system of claim 29 wherein said processor programmed and configured to monitor said trading activity of the instruments at said actuation.

34. The system of claim 30, the processors programmed and configured to receive a bid price for the instrument upon the actuation of the at least one better buyer selector.

35. The system of claim 34, the processors programmed and configured to generate a request to buy the instrument at a value of the offset above the bid price for the instrument.

36. The system of claim 29, the processors programmed and configured to receive an offer price for the instrument upon the actuation of the at least one better seller selector.

37. The system of claim 36, the processors programmed and configured to generate a request to sell the instrument at a value of the offset below the offer price of the instrument.

38. The system of claim 29, the processors programmed and configured to receive an offer price for the instrument upon the actuation of the at least one better seller selector.

39. The system of claim 29, wherein said deactivation of the actuation is based on a timeout, wherein said timeout comprise one of a custom timeout and an interval timeout.

40-41. (canceled)

42. The system of claim 35, the processors programmed and configured to buy the instrument.

43-44. (canceled)

45. The system of claim 37, the processors programmed and configured to sell the instrument.

46. (canceled)

47. A computer-implemented system for trading a financial instrument, the system comprising:
one or more storage devices; and
one or more processors, coupled to the storage devices, the processors programmed and configured to activate by said at least one processor, a first actuation of at least one of a better buyer selector and a better seller selector for the instrument;
said processors programmed and configured to activate by said at least one processor, a second actuation of a better buyer selector and a better seller selector for the instrument;
said processors programmed and configured to monitor trading activity of the instruments at said first and second actuations; and
said processors programmed and configured to deactivate one of the first and the second actuations when the instrument being traded at the first actuation is same as the instrument being traded at the second actuation; wherein said activation and deactivation comprise toggle between the activation of the first and the second actuations and the deactivation of the first and the second actuations of the at least one of a better buyer selector and a better seller selector.

48. A computer readable medium having stored thereon a plurality of instructions on one or more storage devices, the plurality of instructions including instructions which, when executed by at least one processor, cause the processor to perform the steps of a method for trading a financial instrument, said method comprising the steps of:
receiving, by the least one processor, at least one actuation of at least one of a better buyer selector and a better seller selector for the instrument, said better buyer selector functions to activate a request to buy the instrument and said better seller selector functions to activate a request to sell the instrument; and
deactivating, by the at least one processor, the actuation of the at least one of a better buyer selector and a better seller selector based on parameters; wherein said steps of activating and deactivating comprising toggling between the activating and the deactivating of the actuation of the at least one of a better buyer selector and a better seller selector.

49. The method of claim 1 wherein said parameters comprising one of a number of instruments bought and/or sold, market volatility, price volatility of the instrument, market price levels and price level of the instrument.

50. The system of claim 29 wherein said parameters comprising one of a number of instruments bought and/or sold, market volatility, price volatility of the instrument, market price levels and price level of the instrument.

51. The medium of claim 48 wherein said parameters comprising one of a number of instruments bought and/or sold, market volatility, price volatility of the instrument, market price levels and price level of the instrument.
